(19) United States
(12) Patent Application Publication
(10) Pub. No.: US 2013/0248299 A1
(43) Pub. Date: Sep. 26, 2013

(54) ELEVATOR ARRANGEMENT AND METHOD

(71) Applicant: KONE CORPORATION, Helsinki (FI)

(72) Inventors: Jussi PERÄLÄ, Hyvinkaa (FI); Mark PEACOCK, Riihimaki (FI)

(73) Assignee: KONE CORPORATION, Helsinki (FI)

(21) Appl. No.: 13/898,858

(22) Filed: May 21, 2013

Related U.S. Application Data
(63) Continuation of application No. PCT/FI2011/000050, filed on Nov. 24, 2011.

(30) Foreign Application Priority Data
Dec. 1, 2010 (FI) 20106273

(51) Int. Cl. B66B 11/00

(52) U.S. Cl. CPC B66B 11/00
USPC 187/359; 29/401.1

(57) ABSTRACT

A method is provided to manufacture an elevator including an elevator car and a movable supporting platform. The movable supporting platform is in the elevator hoistway and the elevator car is in the elevator hoistway to transport passengers and/or freight between floors. The elevator car is removed from use, after which a lifting phase is performed, in which the supporting platform above the elevator car is lifted higher up in the elevator hoistway, after which the elevator car is again taken into use to move in the elevator hoistway and to transport passengers and/or freight between floors. Guide rails are installed to extend to above the supporting platform. Guide rail safety gears are arranged during the lift to allow movement of the supporting platform upwards and to grip the guide rails as a consequence of downward movement of the supporting platform.

### FIELD OF THE INVENTION

The object of the invention is a method in the manufacture of an elevator and a construction-time elevator arrangement, which elevator is preferably an elevator applicable to passenger transport and/or to freight transport and to be installed in a building. With the method and with the elevator arrangement, an elevator can be taken into service use already during its construction time.

### BACKGROUND OF THE INVENTION

In connection with so-called jump-lifts, the elevator hoistway is taken into use already before the full length of the elevator hoistway has been completed. The top part of the elevator hoistway is constructed at the same time as an elevator car moving in the already completed bottom part of the elevator hoistway serves on the lower floors of the building. In jump-lifts, the elevator car moving in the lower part of the elevator hoistway is supported and moved during the construction-time use suspended on hoisting ropes that are supported by a supporting platform in the elevator hoistway, which ropes are moved with a hoisting machine, which can be supported e.g. on the supporting platform. The installation work in the parts of the elevator hoistway above this supporting platform is done from a movable platform or corresponding. When the part of the elevator hoistway under construction above the supporting platform has reached a sufficient stage of completion, the completed part of the elevator hoistway can be taken into use. In this case a jump-lift is performed, wherein the supporting platform is lifted to a higher position in the elevator hoistway, thus extending the operating area of the elevator car upwards. A worksite crane in use in the construction of the building or a lighter lifting device to be supported on the building and arranged for the site for the purpose of the elevator installation can, for example, be used for the lift. When the elevator hoistway has reached its final height, the jump-lift is converted into the final elevator of the building. In prior art the supporting platform is supported for the period of time between jump-lifts in a manner that allows opening on the guide rails or alternatively on the wall structures of the elevator hoistway resting on support elements comprised in the frame of the supporting platform, each of which elements can be moved in the lateral direction from the supporting platform into an extended position and back towards the platform into a retracted position, supported on which support elements in their extended position the frame of the supporting platform can be lowered to rest on top of the wall structures of the elevator hoistway, for the vertical supporting of the supporting platform in the elevator hoistway, and when in the retracted position of which support elements the supporting platform can be moved in the vertical direction in the elevator hoistway without being obstructed by the support elements. A problem in solutions according to prior art has been that although the solutions have been dimensioned, and the methods otherwise optimized, to be extremely safe, moving a heavy supporting platform in the hoistway has required its momentary removal from the support of the elevator hoistway and has therefore increased the risks to parts below the supporting platform and has made ensuring the safety of the area more awkward.

### AIM OF THE INVENTION

The aim of the invention is to eliminate, among others, the aforementioned drawbacks of prior-art solutions. More particularly the aim of the invention is to produce a method in the manufacture of an elevator that is safer than before and a construction-time elevator arrangement.

### SUMMARY OF THE INVENTION

The invention is based on the concept that the safety of the manufacture of an elevator can be improved by installing, before the lift of the supporting platform, guide rails to extend to above the supporting platform, and by preventing downward creep during the lifting phase of the supporting platform with one or more guide rail safety gears in connection with the supporting platform, which guide rail safety gears are arranged during the aforementioned lift to allow movement of the supporting platform upwards and to grip the aforementioned guide rails as a consequence of downward movement of the supporting platform.

In a basic embodiment of the concept according to the invention in the method in the manufacture of an elevator, which elevator during the construction time comprises an elevator hoistway, an elevator car, a movable supporting platform for supporting the elevator car below it in the elevator hoistway, the movable supporting platform is in its position in the elevator hoistway and the elevator car has been taken into use to move in the aforementioned elevator hoistway and to transport passengers and/or freight between floors. In the method the elevator car is removed from the aforementioned use, after which a lifting phase is performed, in which the supporting platform above the elevator car is lifted higher up in the elevator hoistway, and thus the range of movement of the elevator car is changed to extend farther upwards than before in the elevator hoistway, after which the elevator car is again taken into use to move in the aforementioned elevator hoistway and to transport passengers and/or freight between floors. Before the lift of the supporting platform, guide rails are installed to extend to above the supporting platform, and downward creep during the lifting phase of the supporting platform is prevented with one or more guide rail safety gears in connection with the supporting platform, which guide rail safety gears are arranged during the aforementioned lift to allow movement of the supporting platform upwards and to grip the aforementioned guide rails as a consequence of downward movement of the supporting platform.

In a more refined embodiment of the concept according to the invention the supporting platform comprises guide shoes resting on the aforementioned guide rails, by means of which guide shoes the supporting platform is guided during the lift of it. In this way the lift is controlled and the overall solution is simple and safe.

In a more refined embodiment of the concept according to the invention the aforementioned guide rails, which are installed above the supporting platform before the lift of the supporting platform, are installed on top of the lower guide rails, guided by which lower guide rails the elevator car is arranged to travel during the aforementioned use. In this way the overall solution is simple, cheap, fast and safe.

In a more refined embodiment of the concept according to the invention after lifting the supporting platform the elevator car is again taken into use to move in the aforementioned elevator hoistway and to transport passengers and/or freight between floors, during which use the elevator car reaches to travel, guided by the guide rails, which a guide rail safety gear was arranged to grip during the previous lift as a consequence of downward movement of the supporting platform. In this way the overall solution is simple, safe, cheap and quick to perform.

In a more refined embodiment of the concept according to the invention the guide rail safety gear is arranged during the aforementioned lift to allow movement of the supporting platform upwards and to grip the aforementioned guide rails, by means of the wedge part wedging against the guide rail, as a consequence of downward movement of the supporting platform. Thus the solution is simple and safe.

In a more refined embodiment of the concept according to the invention the guide rail safety gear comprises a wedge part, which is arranged to wedge between the wedge housing of the guide rail safety gear and the guide rail if the guide rail safety gear moves downwards in relation to the guide rail.

In a more refined embodiment of the concept according to the invention the guide rail safety gear comprises a wedge part, which is arranged during a lift to be in constant contact with the guide rail and to wedge between the wedge housing of the guide rail safety gear and the guide rail if the guide rail safety gear moves downwards in relation to the guide rail. Thus the solution is simple and safe. Continuous contact guarantees a fast and error-free reaction to downward creep. Thus the solution is simple and safe.

In a more refined embodiment of the concept according to the invention the supporting platform above the elevator car is lifted higher up in the elevator hoistway with a lifting device, which pulls the supporting platform upwards in the elevator hoistway while resting on a support structure separate to the supporting platform, which support structure is supported in the elevator hoistway above the supporting platform at a distance from the supporting platform, or which is a worksite crane, and which lifting device preferably pulls the supporting platform upwards via a hoisting rope supported on the aforementioned support structure, which hoisting rope reaches from the supporting platform to the aforementioned support structure. In this way the overall solution is simple and long lifts can be performed safely.

In a basic embodiment of the concept according to the invention the elevator arrangement comprises an elevator hoistway, an elevator car, and possibly hoisting roping for supporting and moving the elevator car in the elevator hoistway, a hoisting machine for moving the elevator car e.g. by means of hoisting roping, a movable supporting platform for supporting the elevator car below it in the elevator hoistway e.g. via hoisting roping. The supporting platform can comprise means for the vertical support of the supporting platform in its position in the elevator hoistway, which means can be moved between a space supporting the supporting platform in its position in the vertical direction and a space not supporting the supporting platform in the vertical direction. The elevator arrangement further comprises means for lifting the supporting platform higher up in the elevator hoistway. The arrangement further comprises guide rails extending to above the supporting platform, and in connection with the supporting platform are one or more guide rail safety gears, which are arranged to allow movement of the supporting platform upwards and to grip the guide rails as a consequence of downward movement of the supporting platform. In this way downward movement of the supporting platform can be stopped.

In a more refined embodiment of the concept according to the invention the supporting platform comprises guide shoes resting on the aforementioned guide rails, by means of which guide shoes the supporting platform is arranged to be guided during the lift of it.

In a more refined embodiment of the concept according to the invention the aforementioned guide rails are on top of the guide rails, guided by which the elevator car is arranged to travel during the aforementioned use.

In a more refined embodiment of the concept according to the invention the guide rail safety gear comprises a wedge part, which is arranged to wedge between the wedge housing of the guide rail safety gear and the guide rail if the guide rail safety gear moves downwards in relation to the guide rail.

In a more refined embodiment of the concept according to the invention the guide rail safety gear comprises a wedge part, which is arranged during a lift to be in constant contact with the guide rail and to wedge between the wedge housing of the guide rail safety gear and the guide rail if the guide rail safety gear moves downwards in relation to the guide rail.

In a more refined embodiment of the concept according to the invention the aforementioned wedge part is a roller that rotates against the guide rail during a lift, or a piece that slides against the guide rail during a lift.

In a more refined embodiment of the concept according to the invention the guide rail safety gear comprises gripping means for keeping the wedge part in contact with the guide rail during a lift.

In a more refined embodiment of the concept according to the invention the guide rail safety gear comprises a spring, with which the aforementioned wedge part is arranged during a lift to be pressed into contact with the guide rail.

In a more refined embodiment of the concept according to the invention the means for lifting the supporting platform comprise a lifting device, which is arranged to pull the supporting platform upwards in the elevator hoistway while resting on a support structure separate to the supporting platform, which support structure is either supported in the elevator hoistway above the supporting platform at a distance from the supporting platform, or which is a worksite crane. In this way long and safe lifts can be achieved.

Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the framework of the basic inventive concept in conjunction with other embodiments. The additional features or procedures of each embodiment can also singly and separately from the other embodiments form a separate invention.

### LIST OF FIGURES

In the following, the invention will be described in detail by the aid of some examples of its embodiments with reference to the attached drawings, wherein

FIG. 1a presents a phase of the method according to the invention, in which phase the elevator car is in use.

FIG. 1b presents a phase of the method according to the invention, in which phase the elevator is arranged for the purpose of lifting the supporting platform in a manner according to the invention.

FIG. 1c presents a phase of the method according to the invention, in which phase the supporting platform has been lifted and the elevator car can be transferred into use again.

FIG. 2 presents a diagrammatic view of a preferred embodiment of a guide rail safety gear, with which embodiment the method and elevator arrangement according to the invention can be implemented.

FIG. 3 presents a diagrammatic view, sectioned at the point A-A, of a first alternative for implementing a guide rail safety gear according to FIG. 2.

FIG. 4 presents a diagrammatic view, sectioned at the point A-A, of a second alternative for implementing a guide rail safety gear according to FIG. 2.

### DETAILED DESCRIPTION OF THE INVENTION

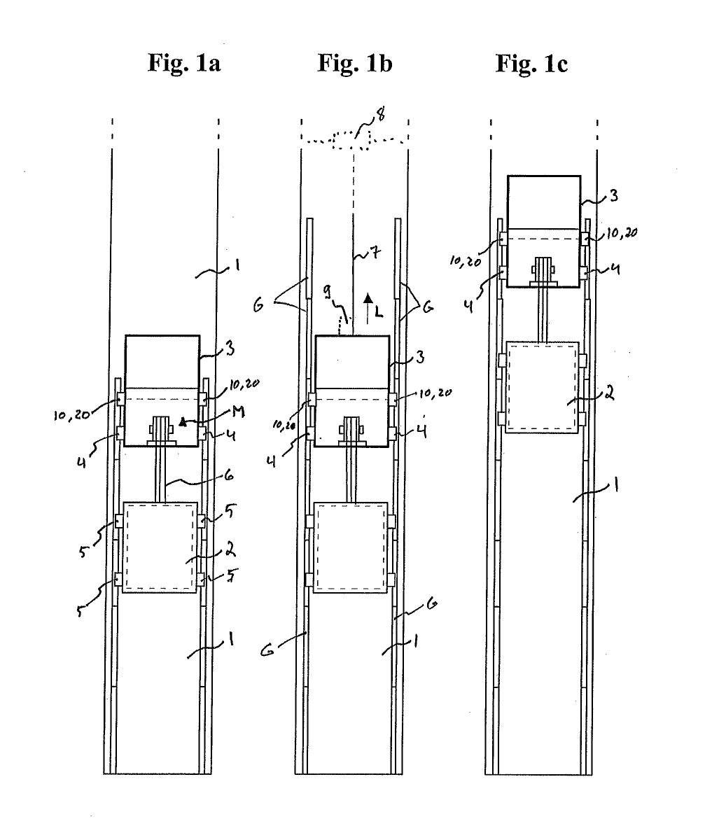

FIG. 1a presents a phase of the method according to the invention during the manufacture of an elevator, in which phase the movable supporting platform 3 for supporting the elevator car 2 below it in the elevator hoistway is in its position in the elevator hoistway 1 and the elevator car 2 is in use to move in the aforementioned elevator hoistway 1 and to transport passengers and/or freight between floors. When the elevator car is in use guide rails, which are presented in FIG. 1b, are installed to extend to above the supporting platform. The aforementioned guide rails can be installed e.g. from a working platform traveling above the supporting platform or, for instance, from scaffolding. When the aforementioned guide rails have been extended to reach to a suitable height above the supporting platform, the elevator car 2 is removed from the aforementioned use, after which a lifting phase is performed, in which the supporting platform 3 above the elevator car 2 is lifted higher up in the elevator hoistway 1, and thus the range of movement of the elevator car 2 is changed to extend farther upwards than before in the elevator hoistway 1. After this the supporting platform is again supported in its position in the hoistway after which the elevator car 2 is again taken into use to move in the aforementioned elevator hoistway 1 and to transport passengers and/or freight between floors. The supporting platform 3 can be moved with a hoist or crane from the position presented in FIG. 1 higher up in the elevator hoistway, to where it can be supported after the lift and the elevator car 2 can again be taken into use. A number of these types of lifts can be performed until the range of movement of the elevator car 2 extends to the desired height in the hoistway, and during the times between consecutive lifts the elevator car is arranged to be taken into the aforementioned use. Downward creep during the lifting phase of the supporting platform 3 is prevented with one or more guide rail safety gears (10, 20) in connection with the supporting platform, which guide rail safety gears are arranged during the aforementioned lift L to allow movement of the supporting platform 3 upwards and to grip the aforementioned guide rails G as a consequence of downward movement of the supporting platform 3. The supporting platform 3 preferably also comprises guide shoes resting on the aforementioned guide rails G, by means of which guide shoes the supporting platform 3 is guided during the lift of it. The aforementioned guide rails G, which are installed above the supporting platform 3 before the lift of the supporting platform 3, and which thus are the guide rails the aforementioned guide rail safety gear is able to grip, are preferably installed on top of the guide rails guided by which the elevator car 2 is arranged to travel (by the aid of the guide shoes 5 of the elevator car) during the aforementioned use. In other words, the guide rails extending to above and to below the supporting platform are of the same guide rail line. When the supporting platform 3 is at the final height of the elevator, or close to said height, the elevator is converted into the final elevator, preferably leaving in place at least some construction-time guide rails, most of the hoistway structure, and most of the construction-time car and possibly also of the counterweight. The aforementioned lift can be performed with some arrangement according to prior art. Preferably it is performed with a lifting device, which pulls the supporting platform upwards in the elevator hoistway while resting on a support structure 8 separate to the supporting platform, which support structure is supported in the elevator hoistway above the supporting platform 3 at a distance from the supporting platform. The lifting device 9 itself can be e.g. in connection with the supporting platform, as presented in the figure. Alternatively, the lift can be performed from above, e.g. with a worksite crane on the roof. The lifting device preferably pulls the supporting platform upwards via a hoisting rope 7 supported on the aforementioned support structure, which hoisting rope reaches from the supporting platform to the aforementioned support structure, as presented in FIG. 1b.

The arrangement according to the invention presented in FIG. 1b comprises an elevator hoistway 1, an elevator car 2, and hoisting roping 6 for supporting and moving the elevator car in the elevator hoistway, and a hoisting machine for moving the hoisting ropes, and a movable supporting platform 3 for supporting the elevator car 2 below it in the elevator hoistway 1 via the hoisting roping. In addition, the arrangement comprises means for lifting the supporting platform higher up in the elevator hoistway guided by the aforementioned guide rails, which means can be any means according to prior art e.g. means lifting with a rope, with a chain or hydraulically by the action of a lifting device. The arrangement further comprises guide rails G extending to above the supporting platform 3, and in connection with the supporting platform are one or more guide rail safety gears 10,20, which are arranged during the lift L to allow movement of the supporting platform 3 upwards and to grip the guide rails G as a consequence of downward movement of the supporting platform 3 for stopping/preventing downward movement of the supporting platform during a lift. FIGS. 1a-1c do not present a possible counterweight, to which the ropes 6 rising from the car to the traction sheave are preferably continued to descend from the traction sheave. The elevator car can be fixed to the supporting platform for the duration of the lift L. The supporting platform 3 preferably comprises guide shoes 4 resting on the aforementioned guide rails G, by means of which guide shoes the supporting platform 3 is arranged to be guided during the lift of it. The guide rails G are preferably on top of the guide rails guided by which the elevator car 2 is arranged to travel during the aforementioned use.

In the presented method and presented arrangement, the supporting platform comprises means (not presented) for the vertical support of the supporting platform 3 in its position in the elevator hoistway 1, which means can be moved between a space supporting the supporting platform 3 in its position in the vertical direction and a space not supporting the supporting platform in the vertical direction. The means can comprise a plurality of support elements belonging to the support frame of the supporting platform 3 that are movable between a position extended from the supporting platform 3 towards the side and a position retracted towards the platform, supported on which support elements in their extended position the frame of the supporting platform 3 can be lowered to rest on top of the wall structures of the elevator hoistway 1 for the vertical supporting of the supporting platform 3 in the elevator hoistway 1, and when in the retracted position of which support elements the supporting platform 3 can be moved in the vertical direction in the elevator hoistway without being obstructed by the support elements, because the other fixed structures of the supporting platform are at a point of the free vertical projection of the hoistway, so they do not obstruct the vertical transfer of the platform. Alternatively the supporting can be performed on guide rails that are already installed.

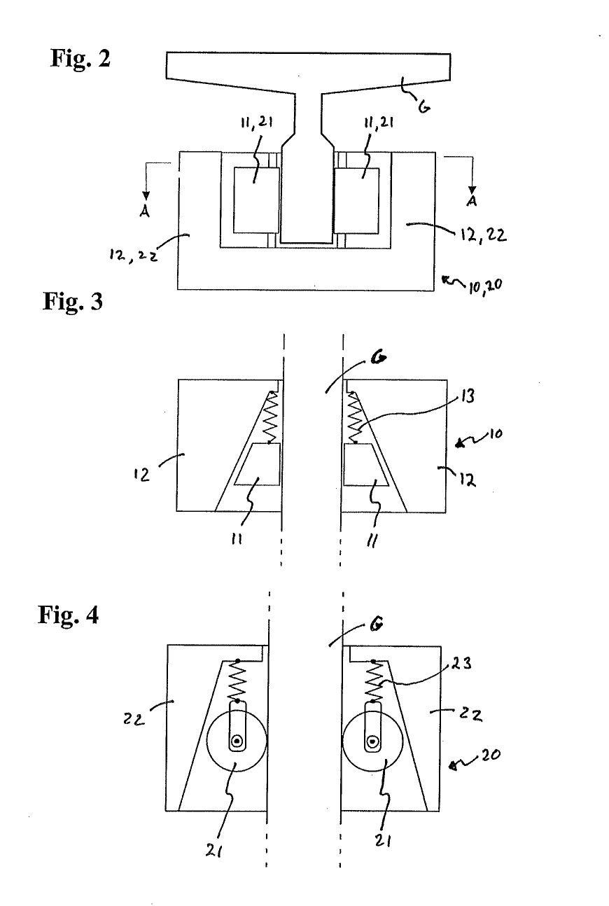

FIG. 2 presents a diagrammatic view of one preferred embodiment of a guide rail safety gear, with which embodiment the method and elevator arrangement according to the invention can be implemented. The guide rail safety gear 10, 20 is arranged during the aforementioned lift to allow movement of the supporting platform 3 upwards and to grip the aforementioned guide rails G as a consequence of downward movement of the supporting platform 3. In the solution presented, the guide rail safety gear (10,20) is arranged during the aforementioned lift to allow movement of the supporting platform 3 upwards and to grip the guide rails G by means of the wedge part 11,21 wedging against the guide rail G as a consequence of downward movement of the supporting platform 3. The wedge part 11,21 is arranged during a lift to be in constant contact with the guide rail G and to wedge between the wedge housing of the guide rail safety gear 10,20 and the guide rail G if the guide rail safety gear 10,20 moves downwards in relation to the guide rail. The wedge part can thus form a follower part in connection with the supporting platform, which part follows the movement of the supporting platform on the basis of the surface of the guide rail, and if the supporting platform moves downwards it is arranged to produce guide rail braking in the manner presented. The aforementioned guide rail safety gear comprises gripping means 13, 23 for keeping the follower part, i.e. in this context the wedge part 11, 21, in contact with the guide rail during a lift. Preferably these means comprise a spring, and the wedge part is therefore preferably arranged to be pressed during a lift into contact with the guide rail in a spring-loaded manner.

FIG. 3 presents a diagrammatic view, sectioned at the point A-A, of another alternative for implementing a guide rail safety gear 10 according to FIG. 2. The aforementioned wedge part 11 is in this embodiment a piece that slides against the guide rail during a lift, which piece wedges between the wedge housing of the guide rail safety gear 10 and the guide rail G if the guide rail safety gear 10 moves downwards in relation to the guide rail G. This is caused because it is between the wedge housing 12 and the guide rail G, which wedge housing 12 has an inclined countersurface to the sliding part 11, which countersurface has an upward tapering distance to the guide rail G. When downward movement of the guide rail safety gear 10 starts, the inertial force of the sliding part 11, but mainly the friction force between the sliding part 11 and the guide rail G, possibly together with the assistance of the spring force, is/are sufficient for the sliding part to hit the inclined surface of the wedge housing 12, which inclined surface has an upward tapering distance to the guide rail G.

FIG. 4 presents a diagrammatic view, sectioned at the point A-A, of another alternative for implementing a guide rail safety gear 20 according to FIG. 2. The aforementioned wedge part 21 is a roller rotating against the guide rail G during a lift, which roller wedges between the wedge housing 22 of the guide rail safety gear 20 and the guide rail G if the guide rail safety gear 20 moves downwards in relation to the guide rail G. This is caused because it is between the wedge housing 22 and the guide rail G, which wedge housing 22 has an inclined countersurface to the roller, which surface has an upward tapering distance to the guide rail G. When downward movement of the guide rail safety gear 20 starts, the inertial force of the wheel and the rotational resistance of the wheel, with the assistance of the spring force is sufficient for the roller to hit the inclined surface of the wedge housing 22, which inclined surface has an upward tapering distance to the guide rail G. The direction of rotation of the roller, which changes when downward movement starts, begins to assist the wedging.

The aforementioned allowing of upward movement and gripping caused as a consequence of downward movement can thus be achieved e.g. with the principle presented by FIG. 2, but also otherwise, e.g. with a guide rail brake that is in connection with the supporting platform and that grips the guide rail, which guide rail brake is arranged to grip if means for detecting the speed of movement and/or the direction of movement of the supporting platform, said means being in connection with the supporting platform and at least partly electronic (and possibly separate to the guide rail brake), notice downward creep of the supporting platform. The means can comprise for this purpose an acceleration sensor, the signal of which can be used as a trigger for the gripping of the guide rail brake or, alternatively, a follower part in connection with the supporting platform, which part follows the movement of the supporting platform on the basis of the surface of the guide rail, such as e.g. a roller running closely along the guide rail, the direction of rotation and/or the speed of rotation of which roller can be used as a trigger for the gripping of the guide rail brake. The supporting platform in this case also comprises electronic means, for starting gripping of the guide rail brake on the basis of the signal produced by the means detecting movement, such as e.g. a control and possibly an actuator, such as a solenoid or corresponding, operating a brake part that grips the guide rail of the guide rail brake.

The elevator to be manufactured with the method and arrangement presented is preferably the final elevator of the building, which elevator is preferably inside the building in the elevator hoistway finally formed for the building. The building is preferably a so-called “high-rise building”. As presented in the figures, the solutions can be implemented such that the supporting platform supports the elevator hoisting machine M (preferably one with a traction sheave), which hoisting machine is arranged, when the elevator is in the aforementioned use, to move the elevator car via the hoisting roping between lifts of the supporting platform, i.e. between jump-lifts. In the aforementioned lift the supporting platform 3 is lifted preferably a distance the length of at least one or more floor-to-floor distance.

As presented in the figures the guide rails of the elevator are preferably at least two guide rail lines, and the supporting platform comprises a guide rail safety gear per each of them. Guide rail safety gears capable of gripping different guide rail lines can be connected with synchronization means, which get the guide rail safety gear of the first guide rail line to grip as a consequence of the gripping of the guide rail safety gear gripping to the second guide rail line. In this way the solution can be formed to be redundant. The synchronization means are illustrated in the figure with dashed lines. With the arrangement and with the method the lift L is preferably of at least one floor-to-floor distance in length and during the aforementioned lift gripping is not caused if the supporting platform does not move downwards. More particularly, the guide rail safety gear is rigidly fixed to the supporting platform and moves according to the movement of the supporting platform.

It is obvious to the person skilled in the art that the invention is not limited to the embodiments described above, in which the invention is described using examples, but that many adaptations and different embodiments of the invention are possible within the frameworks of the inventive concept defined by the claims presented below.

1. Method in the manufacture of an elevator, which elevator comprises during the manufacture
an elevator hoistway,
an elevator car,
a movable supporting platform for supporting the elevator car below it in the elevator hoistway,
in which method the movable supporting platform is in its position in the elevator hoistway and the elevator car has been taken into use to move in the aforementioned elevator hoistway and to transport passengers and/or freight between floors, in which method the elevator car is removed from the aforementioned use, after which a lifting phase is performed, in which the supporting platform above the elevator car is lifted higher up in the elevator hoistway, and thus the range of movement of the elevator car is changed to extend farther upwards than before in the elevator hoistway, after which the elevator car is again taken into use to move in the aforementioned elevator hoistway and to transport passengers and/or freight between floors, wherein before the lift of the supporting platform, guide rails are installed to extend to above the supporting platform, and downward creep during the lifting phase of the supporting platform is prevented with one or more guide rail safety gears in connection with the supporting platform, which guide rail safety gears are arranged during the aforementioned lift to allow movement of the supporting platform upwards and to grip the aforementioned guide rail as a consequence of downward movement of the supporting platform.

2. Method according to claim 1, wherein the supporting platform comprises guide shoes resting on the aforementioned guide rails, by means of which guide shoes the supporting platform is guided during the lift of it.

3. Method according to claim 1, wherein the aforementioned guide rails, which are installed above the supporting platform before the lift of the supporting platform, are installed on top of the lower guide rails, guided by which lower guide rails the elevator car is arranged to travel during the aforementioned use.

4. Method according to claim 1, wherein after the lift of the supporting platform the elevator car is again taken into use to move in the aforementioned elevator hoistway and to transport passengers and/or freight between floors, during which use the elevator car reaches to travel, guided by the guide rails, which a guide rail safety gear was arranged to grip during the previous lift as a consequence of downward movement of the supporting platform.

5. Method according to claim 1, wherein the guide rail safety gear is arranged during the aforementioned lift to allow movement of the supporting platform upwards and to grip the aforementioned guide rails, by means of the wedge part wedging against the guide rail, as a consequence of downward movement of the supporting platform.

6. Method according to claim 1, wherein the supporting platform is lifted higher up in the elevator hoistway with means for lifting the supporting platform, which means comprise a lifting device, which pulls the supporting platform upwards in the elevator hoistway while resting on a support structure separate to the supporting platform, which support structure is either supported in the elevator hoistway above the supporting platform at a distance from the supporting platform, or which is a worksite crane.

7. Elevator arrangement, which comprises
an elevator hoistway,
an elevator car,
a movable supporting platform for supporting the elevator car below it in the elevator hoistway,
means for lifting the supporting platform higher up in the elevator hoistway,
wherein the arrangement comprises guide rails extending to above the supporting platform, and in that in connection with the supporting platform are one or more guide rail safety gears, which are arranged to allow movement of the supporting platform upwards and to grip the guide rails as a consequence of downward movement of the supporting platform.

8. Elevator arrangement according to claim 1, wherein the supporting platform comprises guide shoes resting on the aforementioned guide rails, by means of which guide shoes the supporting platform is arranged to be guided during the lift of it.

9. Elevator arrangement according to claim 1, wherein the aforementioned guide rails are on top of the guide rails, guided by which the elevator car is arranged to travel during the aforementioned use.

10. Elevator arrangement according to claim 1, wherein the guide rail safety gear (10,20) comprises a wedge part, which is arranged to wedge between the wedge housing of the guide rail safety gear and the guide rail if the guide rail safety gear moves downwards in relation to the guide rail.

11. Elevator arrangement according to claim 1, wherein the guide rail safety gear comprises a wedge part, which is arranged during a lift to be in constant contact with the guide rail and to wedge between the wedge housing of the guide rail safety gear and the guide rail if the guide rail safety gear moves downwards in relation to the guide rail.

12. Elevator arrangement according to claim 1, wherein the aforementioned wedge part is a roller that rotates against the guide rail during a lift, or a piece that slides against the guide rail during a lift.

13. Elevator arrangement according to claim 1, wherein the guide rail safety gear comprises gripping means for keeping the wedge part in contact with the guide rail during a lift.

14. Elevator arrangement according to claim 1, wherein the guide rail safety gear comprises a spring, with which the aforementioned wedge part is arranged during a lift to be pressed into contact with the guide rail.

15. Elevator arrangement according to claim 1, wherein the means for lifting the supporting platform comprise a lifting device, which is arranged to pull the supporting platform upwards in the elevator hoistway while resting on a support structure separate to the supporting platform, which support structure is either supported in the elevator hoistway above the supporting platform at a distance from the supporting platform, or which is a worksite crane.

16. Method according to claim 2, wherein the aforementioned guide rails, which are installed above the supporting platform before the lift of the supporting platform, are installed on top of the lower guide rails, guided by which lower guide rails the elevator car is arranged to travel during the aforementioned use.

17. Method according to claim 2, wherein after the lift of the supporting platform the elevator car is again taken into use to move in the aforementioned elevator hoistway and to transport passengers and/or freight between floors, during which use the elevator car reaches to travel, guided by the guide rails, which a guide rail safety gear was arranged to grip during the previous lift as a consequence of downward movement of the supporting platform.

18. Method according to claim 3, wherein after the lift of the supporting platform the elevator car is again taken into use to move in the aforementioned elevator hoistway and to transport passengers and/or freight between floors, during which use the elevator car reaches to travel, guided by the guide rails, which a guide rail safety gear was arranged to grip during the previous lift as a consequence of downward movement of the supporting platform.

19. Method according to claim 2, wherein the guide rail safety gear is arranged during the aforementioned lift to allow movement of the supporting platform upwards and to grip the aforementioned guide rails, by means of the wedge part wedging against the guide rail, as a consequence of downward movement of the supporting platform.

20. Method according to claim 3, wherein the guide rail safety gear is arranged during the aforementioned lift to allow movement of the supporting platform upwards and to grip the aforementioned guide rails, by means of the wedge part wedging against the guide rail, as a consequence of downward movement of the supporting platform.
